(19) United States
(12) Patent Application Publication
(10) Pub. No.: US 2002/0090336 A1
(43) Pub. Date: Jul. 11, 2002

(54) Device and method for normalizing gas flow through multiple reaction vessels

(75) Inventors: James Claude Carnahan, Niskayuna, NY (US); Tracey Marie Jordan, Schenectady, NY (US)

Correspondence Address: GENERAL ELECTRIC COMPANY, CRD PATENT DOCKET ROOM 4A59, P O BOX 8, BUILDING K 1 SALAMONE, SCHENECTADY, NY, 12301, US

(73) Assignee: General Electric Company

(21) Appl. No.: 09/755,573

(22) Filed: Jan. 8, 2001

(51) Int. Cl. C01F 1/00; C01C 1/00

(52) U.S. Cl. 423/659

(57) ABSTRACT

A device and method for normalizing the gas flow through multiple reaction vessels used for conducting and analyzing simultaneous reactions. The device includes a plurality of reaction vessels having different first gas flow rates and an adjustment mechanism for adjusting the gas flow through each of the reaction vessels to produce a second gas flow rate that is substantially the same for each of the reaction vessels. The method includes connecting the reaction vessels to a controlled vacuum source, one at a time, and adding an amount of various condensed phased materials to the reaction vessels to produce a predetermined second pressure drop reading corresponding to a second gas flow rate that is substantially the same for each of the reaction vessels.

### BACKGROUND OF THE INVENTION

The present invention relates generally to devices and methods for conducting simultaneous chemical reactions. More specifically, the present invention is directed to devices and methods for normalizing the gas flow through multiple reaction vessels used for conducting and analyzing simultaneous reactions.

Reactions, such as gas-condensed phase reactions, are studied to identify and measure their products. Gas-condensed phase reactions involve at least one condensed phase catalyst reacting with at least one gaseous reagent, or at least one condensed phase reagent reacting with at least one gaseous reagent, to convert the materials into some other species. A condensed phase material is a material that is either a solid, a liquid, a solid suspended in a liquid, or a liquid dispersed on a solid. The catalysts, reagents, products, and conditions of these reactions are evaluated to determine if potentially useful combinations have been discovered.

Traditionally, gas-condensed phase reactions have been carried out in pressure vessels, autoclaves, or single, tubular, flow-through reactors. Due to operational setup requirements and time limitations associated with traditional methods and devices, typically only a few reactions could be completed in a given work day. This was sufficient in the past, when the condensed phase catalysts and reagents had to be generated one combination at a time. However, catalysts and reagents can now be prepared using combinatorial synthesis techniques, which rapidly provides large numbers of test materials in small quantities. Gas-condensed phase reactions using these combinatorially synthesized materials can also now be carried out in fast, parallel reactors, utilizing multiple reaction vessels. While allowing multiple gas-condensed phase reactions to be studied simultaneously, these reactors may utilize simplified temperature and gas flow controls and a common gas feed with a fixed pressure. In order for these reactors to function properly, however, the gas flow rate through each reaction vessel must be substantially the same.

What is needed are devices and methods for normalizing the gas flow through multiple reaction vessels which will be connected to a common gas feed with a fixed pressure. What is also needed are devices and methods for normalizing the gas flow through multiple reaction vessels where each reaction vessel may contain a different condensed phase catalyst or reagent, with each catalyst or reagent having a different porosity. Finally, what is needed are devices and methods for normalizing the gas flow through multiple reaction vessels that require minimal time, effort, and infrastructure.

### SUMMARY OF THE INVENTION

Accordingly, the above identified shortcomings are overcome by the present invention, which relates to devices and methods for conducting simultaneous chemical reactions. The present invention discloses a device and method for normalizing the gas flow through multiple reaction vessels used for conducting and analyzing simultaneous gas-condensed phase reactions, thereby allowing such reactions to be carried out quickly and efficiently in parallel reactors.

In one embodiment, the device for normalizing the gas flow through multiple reaction vessels includes a plurality of reaction vessels, each of the reaction vessels having a different first gas flow rate when connected in parallel to a common gas feed with a fixed pressure and the gas flow through each of the reaction vessels being adjustable. Further, the device includes an adjustment mechanism for adjusting the gas flow through each of the reaction vessels to produce a second gas flow rate that is substantially the same for each of the reaction vessels when connected in parallel to a common gas feed with a fixed pressure.

In another embodiment, the method for normalizing the gas flow through multiple reaction vessels includes connecting each of a plurality of reaction vessels having different first gas flow rates, one at a time, to a controlled vacuum source. Further, the method includes adding an amount of various condensed phased materials to the reaction vessels to produce a predetermined second pressure drop reading corresponding to a second gas flow rate that is substantially the same for each of the reaction vessels. In this manner, the gas flow through each of the reaction vessels is normalized.

Further aspects and advantages of the present invention will become more clearly apparent to those skilled in the art during the course of the following description, references being made to the accompanying drawings which illustrate some preferred forms and embodiments of the present invention and wherein like characters of reference designate like parts throughout the drawings.

### BRIEF DESCRIPTION OF THE DRAWINGS

FIG. 1 is a schematic diagram of one embodiment of the gas flow normalization device of the present invention; and

FIG. 2 is a functional block diagram of one embodiment of the gas flow normalization method of the present invention.

### DETAILED DESCRIPTION OF THE INVENTION

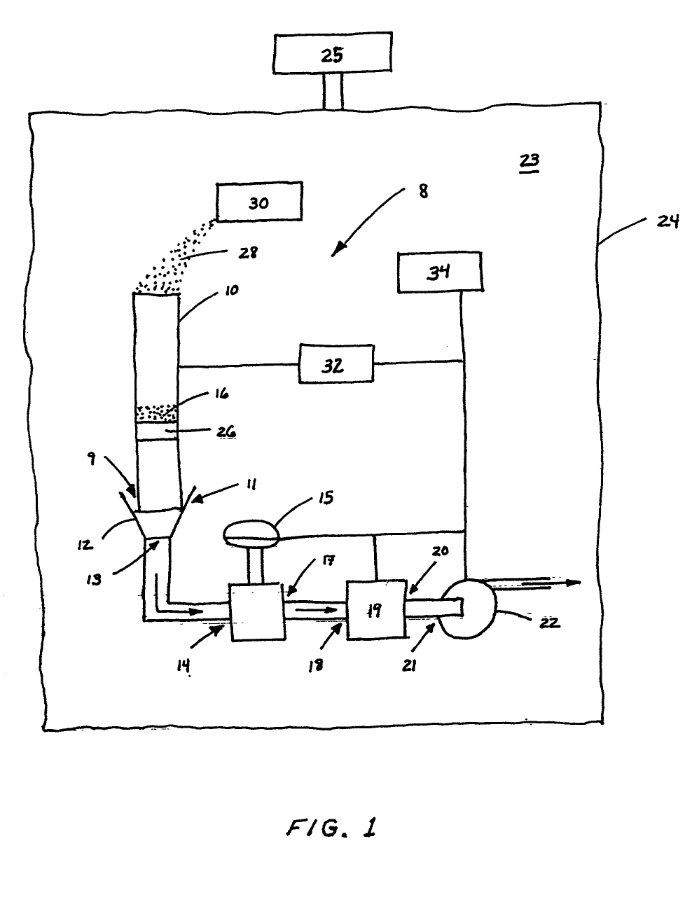

Referring to FIG. 1, there is shown a schematic diagram of one embodiment of a device 8 for normalizing the gas flow through a reaction vessel 10. Reaction vessels are used for conducting and analyzing simultaneous chemical reactions, especially gas-condensed phase reactions. These reactions may be carried out in parallel reactors utilizing multiple reaction vessels, with a common gas feed having a fixed pressure supplying the gas phase reagent to each reaction vessel. In order for such parallel reactors to work properly, the gas flow through each reaction vessel must be substantially the same. In FIG. 1, the exit end 9 of a reaction vessel 10, through which the gas flow rate is adjustable, is in communication with the upstream end 11 of a fitting 12, that supports the reaction vessel 10 and provides a gas-tight seal, preventing leaks at the exit end 9 of the reaction vessel 10. The downstream end 13 of the fitting 12 is operatively connected to the upstream end 14 of a vacuum gauge 15 for measuring and displaying the pressure downstream of a condensed phase material bed 16 disposed within the reaction vessel 10. The vacuum gauge 15 may be, for example, an electronic pressure gauge, a Bourdon tube-type gauge, or a fluid filled manometer. The downstream end 17 of the vacuum gauge 15 is operatively connected to the upstream end 18 of a gas flow controller 19 for controlling the gas flow rate through the device 8. The gas flow controller 19 may be, for example, a mass flow controller, a rotometer, or an orifice-type flow controller. The downstream end 20 of the gas flow controller 19 is operatively connected to the upstream end 21 of a controlled vacuum source 22 that provides a steady gas flow and pressure downstream of the condensed phase material bed 16 and throughout the device 8. The controlled vacuum source 22 may be, for example, a pump, a blower, or a central vacuum source. Additionally, the gas 23 drawn into the controlled vacuum source 22, through the reaction vessel 10 and the remainder of the device 8, may be air or any other gas if, for example, the catalyst, reagent, or reaction of interest is sensitive to oxygen. In the event that a gas 23 other than air is used to normalize the gas flow through a given reaction vessel 10 or group of reaction vessels, the device 8 may be contained within a dry box or glove bag 24 and the gas 23 may be supplied to the device 8 by a gas source 25. Nitrogen gas may be used, for example.

The reaction vessel 10 may be tubular, or any shape capable of forming a gas-tight seal with the upstream end 11 of the fitting 12 at the exit end 9 of the reaction vessel 10. Likewise, in order to assure a gas-tight seal, the fitting 12 may be any suitable shape, preferably corresponding to the shape of the reaction vessel 10, and may be made of any suitable material. The fitting 12 may comprise, for example, a simple rubber hose or a rigid pipe with an elastomer seal between it and the reaction vessel 10. The reaction vessel 10 may be made of metal, any suitable material that is capable of being internally plated or coated with metal, or any suitable material that is capable of providing an inert environment for gas-condensed phase reactions. In the event that reactions other than gas-condensed phase reactions are being carried out, any other suitable material compatible with those reactions may also be used.

A condensed phase material bed support 26 is disposed within the reaction vessel 10. The condensed phase material bed support 26 may be made of metal, such as stainless steel or a nickel alloy, a glass, a ceramic, or any other suitable material. It is secured within the reaction vessel 10 at a position dictated by heating and other requirements of the gas-condensed phase reactions being studied and may be attached inside of the reaction vessel 10 by, for example, swaging or press-fitting. The condensed phase material bed support 26 is porous, such that gas 23 may flow through it but it will support the condensed phase material bed 16. The support 26 may take the form of a sintered plug, a screen, or a filter. The support 26 may also be a fibrous substance or frit, for example. The condensed phase material bed 16 comprises a porous, condensed phase material 28, such as a catalyst or reagent. A condensed phase catalyst or reagent may be a solid, a liquid, a solid suspended in a liquid, or a liquid dispersed on a solid. For example, the condensed phase material bed 16 may comprise a powder or beads. Preferably, the condensed phase catalyst or reagent is a catalyst or reagent suitable for catalytic or consumptive reactions. For example, the condensed phase catalyst or reagent may be a supported catalyst, such as platinum chloride or an aluminum based catalyst or reagent; a surface modified silica gel; a heterogeneous catalyst, comprising a ceramic with a metal, such as platinum, palladium, rhodium, and manganese; a chromium oxide catalyst; and a liquid at reaction temperature deposited on a solid. The gas flow through the reaction vessel 10 is adjusted by adding an amount of condensed phase material 28 to or removing an amount of condensed phase material 28 from the condensed phase material bed 16, increasing or decreasing the volume or height of the condensed phase material bed 16. The condensed phase material 28 may be delivered to or removed from the condensed phase material bed 16 disposed within the reaction vessel 10 by a material source 30. Optionally, an agitating device 32 may also be used to agitate the reaction vessel and/or condensed phase material 28 to ensure that the condensed phase material bed 16 is in its most settled or stable state within the reaction vessel 10. Suitable examples of agitating devices 32 include, for example: a buzzer, mechanical agitators, magnetic agitators, electromechanical agitators, intermittent manual agitation with a finger or mechanical object, etc.

The adjustment mechanism, described above, allows the gas flow rate through the reaction vessel 10 to be varied. For example, the reaction vessel 10, when unloaded or filled with an initial load of condensed phase material 28, has a corresponding first gas flow rate when connected with the plurality of reaction vessels to a common gas feed with a fixed pressure. This first gas flow rate corresponds to a first pressure drop reading on the vacuum gauge 15 when the reaction vessel 10 is made part of the device 8. Each of the plurality of reaction vessels 10 to be normalized may have a different first gas flow rate that is dependent upon multiple factors including, for example, the diameter of the reaction vessel 10; the porosity of the condensed phase material bed support 26; the method and precision of attachment of the condensed phase material bed support 26 inside the reaction vessel 10; and the type, porosity, and depth of condensed phase material 28 disposed within the reaction vessel 10. The gas flow rate of each of the plurality of reaction vessels 10 may be adjusted to the same second gas flow rate, and thereby normalized, by disposing the appropriate amount of condensed phase material 28 within each of the reaction vessels 10 such that the vacuum gauge 15 reads the same predetermined second pressure drop for each. Thus, this adjustment mechanism ensures that, when the plurality of reaction vessels 10 are connected, in parallel, to a common gas feed with a fixed pressure, all gas flow rates are substantially the same and the gas flow is not diverted through a low-resistance reaction vessel 10.

Finally, the device 8 described above may optionally be controlled by a controller 34. The controller 34 is a computer system having inputs, outputs, a memory, and a processor for receiving, sending, storing, and processing signals and data to operate, monitor, record, and otherwise functionally control the operation of the device 8. The controller 34 includes an interface board for integrating all of the components of the device 8 and may include a motion controller for controlling the movements of the material source 30. The controller 34 may also include a keyboard for inputting data and commands, a video display for displaying information, and a printer for printing information. The controller 34 may further include software, hardware, firmware, and other similar components and circuitry for operating the device 8. The controller 34 may be a single device, or it may be a plurality of devices working in concert. The controller 34 is preferably in communication with all of the other components of the device 8, including the controlled vacuum source 22, the gas flow controller 19, the vacuum gauge 15, the agitating device 32, the material source 30, and optionally the gas source 25, to coordinate the operations of the device 8. In the event that a large number of reaction vessels 10 are utilized, the controller 34 may also be in communication with a robotic reaction tube handling device.

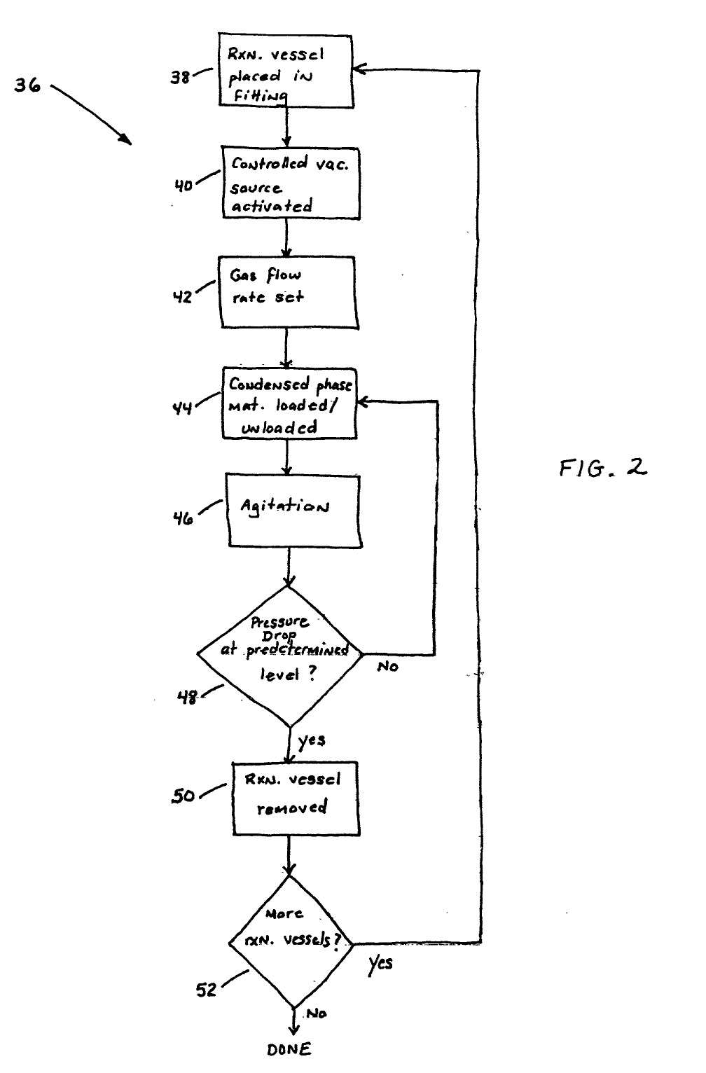

Referring now to FIG. 2, there is shown a functional block diagram of one embodiment of a method 36 for normalizing the gas flow through multiple reaction vessels 10 (FIG. 1). The gas flow rates of multiple reaction vessels 10 are normalized by placing a reaction vessel 10 with a first gas flow rate into the fitting 12 (FIG. 1) (Block 38). As described above, the reaction vessel 10 may be unloaded or filled with an initial load of condensed phase material 28 (FIG. 1). The controlled vacuum source 22 (FIG. 1) is then activated (Block 40), providing a steady gas flow through the reaction vessel 10 and the rest of the device 8 (FIG. 1). The steady gas flow level, or vacuum level, which remains constant as the gas flow through each reaction vessel 10 is normalized, is then set (Block 42). The gas flow controller 19 (FIG. 1) is adjusted such that the vacuum gauge 15 (FIG. 1) reads a measurable first pressure drop corresponding to a measurable, predetermined second pressure drop within a predetermined range (Block 42). In other words, the controlled vacuum source 22 and the gas flow controller 19 are set up to provide a steady gas flow, or vacuum, such that both the first and second pressure drop readings, corresponding to the first and second gas flow rates of the reaction vessel 10 when the plurality of reaction vessels 10 are connected to a common gas feed with a fixed pressure, will be measurable by the vacuum gauge 15. The predetermined pressure drop range within which the predetermined second pressure drop must fall depends on such factors as the type of condensed phase materials 28 being used and their porosity; the required range for the amount of catalysts or reagents for the reactions of interest; the required range for the gas flow rate required for the reactions of interest; the diameter of the reaction vessels 10 being used; the measurement range of the vacuum gauge 15 being used, experience with prior gas-condensed phase reactions, etc. The predetermined second pressure drop reading is a conveniently measured pressure drop level selected from this range. Once a steady gas flow, or vacuum, is established, one or a combination of a plurality of condensed phase materials 28 are added to the reaction vessel 10 until the vacuum gauge 15 reads the predetermined second pressure drop (Block 44). Condensed phase material 28 is added to the reaction vessel from a material source 30 (FIG. 1). For example, condensed phase material 28 may be added to the reaction vessel 10 by hand, or with the assistance of robotic fills, scoops, or conveyors. If the predetermined second pressure drop reading is exceeded during loading (Block 48), condensed phase material 28 is removed until the vacuum gauge 15 reads the predetermined second pressure (Block 44). Removal may be accomplished using a vacuum probe, for example.

As condensed phase material 28 is added to the condensed phase material bed 16 (FIG. 1) disposed within the reaction vessel 10, it may be agitated (Block 46) by an agitating device 32 (FIG. 1), causing it to settle to a gravitational equilibrium. This assures that the condensed phase material bed 16 is in its most stable state under normalization conditions and provides consistent gas flow characteristics. Agitation may be carried out by agitating the reaction vessel 10 and/or condensed phase material bed 16 with a buzzer, mechanical agitators, magnetic agitators, electromechanical agitators, intermittent manual agitation with a finger or mechanical object, etc.

After the predetermined second pressure drop reading, and therefore second gas flow rate, is achieved for a given reaction vessel 10, it is removed (Block 50) and any remaining subsequent reaction vessels 10 are normalized using the same method (Block 52), achieving the same predetermined second pressure drop reading, and therefore second gas flow rate, for each reaction vessel 10. Thus, gas-condensed phase reactions can be efficiently carried out with parallel reactors utilizing multiple reaction vessels 10 with a common gas feed having a fixed pressure.

### EXAMPLE

The following is a working example utilizing the devices and methods described above. This example is to be construed as an illustration of the principles of the present invention, and should not be considered as limiting the scope of the invention in any manner.

A set of 32¼ inch outside diameter stainless steel reaction tubes were fitted with sintered metal frits of 10 micron porosity to serve as condensed phase material bed supports. The device described above was constructed using a Sargent-Welch Duoseal vacuum pump (model 1380B-01, W. M. Welch Manufacturing Co., Chicago, Ill.) as a controlled vacuum source, a rotometer (BrooksMite 2700, Emerson Electric Co., Hatfield, Pa.) with a capacity of 5 standard cubic feet per hour air as a flow controller, and a Bourdon tube-type vacuum gauge (Ameteck US Gauge model P-500 (30″ vacuum to 15 psi range) Sellersville, Pa.). Each reaction tube was inserted into the device, one tube at a time, and loaded with approximately 100 milligrams of KOH-treated silica gel of approximately 60 mesh size until the vacuum gauge read 5 inches of mercury. Each tube was gently tapped with a metal rod until the vacuum stabilized and additional silica gel was added to bring the vacuum to the desired, predetermined level. The weights of the added silica gel were determined by weighing the tubes before and after loading. The tubes were mounted in a 32-tube parallel reactor that was run under pressure control. The flow rates through the loaded reaction tubes were measured under reaction conditions with a soap-bubble flow meter. The average flow rate for the 32 reaction tubes in the initially packed condition measured at room temperature was 2.86 milliliters/minute and the standard deviation was 0.193 milliliters/minute for a % RSD of 6.8%. Thus, the devices and methods described above allow the gas flow through multiple reaction vessels to be normalized effectively, wherein each reaction vessel has substantially the same gas flow rate.

For the purposes of promoting an understanding of the principles of the present invention, references have been made to some of the preferred embodiments of the invention, and specific language used to describe the same. It is nevertheless understood that no limitation of the scope of the present invention is thereby intended. The terminology used herein is for the purpose of description, and not limitation. Any modifications of or variations in the depicted device or method, and such further applications of the principles of the present invention, as would normally occur to one skilled in the art, are considered to be within the spirit and scope of this invention. For example, features depicted or described as part of one embodiment can be used on another embodiment to yield a still further embodiment. It is intended that the present invention cover such modifications and variations as come within the spirit and scope of the appended claims and their equivalents.

What is claimed is:

1. A device for normalizing the gas flow through multiple reaction vessels, comprising:
a plurality of reaction vessels, each of the plurality of reaction vessels having an inlet end and an exit end, the gas flow through each of the plurality of reaction vessels being adjustable, and each of the plurality of reaction vessels having a first gas flow rate; and
an adjustment mechanism operable for adjusting the gas flow through each of the plurality of reaction vessels to produce a second gas flow rate.

2. The device of claim 1, wherein the first gas flow rate exists when the plurality of reaction vessels are connected in parallel to a common gas feed with a fixed pressure, and is different for each of the plurality of reaction vessels.

3. The device of claim 1, wherein the second gas flow rate exists when the plurality of reaction vessels are connected in parallel to a common gas feed with a fixed pressure, and is substantially the same for each of the plurality of reaction vessels.

4. The device of claim 1, wherein each of the plurality of reaction vessels has appropriate supports for supporting a condensed phase material bed disposed within each of the plurality of reaction vessels, the gas flow through each of the plurality of reaction vessels being adjusted by varying the amount of condensed phase material composing the condensed phase material bed.

5. The device of claim 4, wherein the support for supporting the condensed phase material bed disposed within each of the plurality of reaction vessels is a sintered plug, a screen, a filter, a frit, a fibrous substance, or any other suitable porous structure or material.

6. The device of claim 4, wherein the condensed phase material bed is composed of a condensed phase catalyst or reagent suitable for catalytic or consumptive reactions, or any other suitable porous material.

7. The device of claim 1, further comprising a vacuum gauge operatively connected to the exit end of one of the plurality of reaction vessels, wherein the vacuum gauge is operable for measuring and displaying the pressure drop across the reaction vessel.

8. The device of claim 1, further comprising a gas flow controller operatively connected to a vacuum gauge, wherein the gas flow controller is operable for controlling the gas flow rate through each of the plurality of reaction vessels to produce a measurable first pressure drop reading on the vacuum gauge at a chosen gas flow rate and a measurable, predetermined second pressure drop reading within a predetermined range on the vacuum gauge at the chosen gas flow rate.

9. The device of claim 1, further comprising a controlled vacuum source operatively connected to a gas flow controller, wherein the controlled vacuum source is operable for providing a steady chosen gas flow through each of the plurality of reaction vessels.

10. The device of claim 1, further comprising a fitting sealingly connecting each of the plurality of reaction vessels, one at a time, to a vacuum source, the fitting having a support for mounting each of the plurality of reaction vessels and preventing gas leaks at the exit end of each of the plurality of reaction vessels.

11. The device of claim 10, wherein the fitting comprises a material providing a gas-tight seal.

12. The device of claim 1, wherein each of the plurality of reaction vessels is any shape that it capable of sealingly engaging a fitting connecting each of the plurality of reaction vessels to a vacuum source.

13. The device of claim 1, wherein each of the plurality of reaction vessels is any suitable material that is capable of providing an inert environment for gas-condensed phase reactions.

14. The device of claim 4, further comprising a means to agitate the reaction vessel and/or condensed phase material bed.

15. A method for normalizing the gas flow through multiple reaction vessels, comprising:
activating a controlled vacuum source to provide a steady gas flow;
sealingly connecting one of a plurality of reaction vessels with a first gas flow rate to the controlled vacuum source;
setting a gas flow controller to a gas flow rate to produce a measurable first pressure drop reading on a vacuum gauge at a chosen gas flow rate and a measurable, predetermined second pressure drop reading within a predetermined range on the vacuum gauge at the chosen gas flow rate;
adding an amount of at least one of a plurality of condensed phased materials to the reaction vessel with the first gas flow rate to produce the predetermined second pressure drop reading corresponding to a second gas flow rate; and
replacing the reaction vessel with each of the plurality of reaction vessels, in turn, and adding an amount of at least one of the plurality of condensed phase materials to each of the plurality of reaction vessels, each with a first gas flow rate, to produce the predetermined second pressure drop reading corresponding to the second gas flow rate.

16. The method of claim 15, wherein the first gas flow rate exists when the plurality of reaction vessels are connected in parallel to a common gas feed with a fixed pressure, and is different for each of the plurality of reaction vessels.

17. The method of claim 15, wherein the second gas flow rate exists when the plurality of reaction vessels are connected in parallel to a common gas feed with a fixed pressure, and is substantially the same for each of the plurality of reaction vessels.

18. The method of claim 15, wherein the predetermined second pressure drop and the predetermined second pressure drop range are dependent on such factors as the type of condensed phase materials being used and their porosity; the required range for the amount of catalysts or reagents for the reactions of interest; the required range for the gas flow rate required for the reactions of interest; the diameter of the reaction vessels being used; the measurement range of the vacuum gauge being used, experience with prior gas-condensed phase reactions; and any other similar factors.

19. The method of claim 15, wherein each of the plurality of reaction vessels has appropriate supports for supporting a condensed phase material bed disposed within each of the plurality of reaction vessels, the gas flow through each of the plurality of reaction vessels being adjusted by varying the amount of condensed phase material composing the condensed phase material bed.

20. The method of claim 19, further comprising agitating the reaction vessel and/or condensed phase material bed.

21. A device for normalizing the gas flow through multiple reaction vessels, comprising:
a plurality of reaction vessels, each of the plurality of reaction vessels having an inlet end and an exit end, the gas flow through each of the plurality of reaction vessels being adjustable, and each of the plurality of reaction vessels having a first gas flow rate, existing when the plurality of reaction vessels are connected in parallel to a common gas feed with a fixed pressure, wherein the first gas flow rate is different for each of the plurality of reaction vessels; and
an adjustment mechanism operable for adjusting the gas flow through each of the plurality of reaction vessels to produce a second gas flow rate, existing when the plurality of reaction vessels are connected in parallel to a common gas feed with a fixed pressure, wherein the second gas flow rate is substantially the same for each of the plurality of reaction vessels.

22. The device of claim 21, wherein each of the plurality of reaction vessels has appropriate supports for supporting a condensed phase material bed disposed within each of the plurality of reaction vessels, the gas flow through each of the plurality of reaction vessels being adjusted by varying the amount of condensed phase material composing the condensed phase material bed.

23. The device of claim 22, wherein the support for supporting the condensed phase material bed disposed within each of the plurality of reaction vessels is a sintered plug, a screen, a filter, a frit, a fiber, or any other suitable porous structure or material.

24. The device of claim 22, wherein the condensed phase material bed is composed of a condensed phase catalyst or reagent suitable for catalytic or consumptive reactions, or any other suitable porous material.

25. The device of claim 21, further comprising a vacuum gauge operatively connected to the exit end of one of the plurality of reaction vessels, wherein the vacuum gauge is operable for measuring and displaying the pressure drop across the reaction vessel.

26. The device of claim 21, further comprising a gas flow controller operatively connected to a vacuum gauge, wherein the gas flow controller is operable for controlling the gas flow rate through each of the plurality of reaction vessels to produce a measurable first pressure drop reading on the vacuum gauge at a chosen gas flow rate and a measurable, predetermined second pressure drop reading within a predetermined range on the vacuum gauge at the chosen gas flow rate.

27. The device of claim 21, further comprising a controlled vacuum source operatively connected to a gas flow controller, wherein the controlled vacuum source is operable for providing a steady chosen gas flow through each of the plurality of reaction vessels.

28. The device of claim 21, further comprising a fitting sealingly connecting each of the plurality of reaction vessels, one at a time, to a vacuum source, the fitting having a support for mounting each of the plurality of reaction vessels and preventing gas leaks at the exit end of each of the plurality of reaction vessels.

29. The device of claim 28, wherein the fitting comprises a material providing a gas-tight seal.

30. The device of claim 21, wherein each of the plurality of reaction vessels is any shape that it capable of sealingly engaging a fitting connecting each of the plurality of reaction vessels to a vacuum source.

31. The device of claim 21, wherein each of the plurality of reaction vessels is any suitable material that is capable of providing an inert environment for gas-condensed phase reactions.

32. The device of claim 22, further comprising a means to agitate the reaction vessel and/or condensed phase material bed.

33. A method for normalizing the gas flow through multiple reaction vessels, comprising:
activating a controlled vacuum source to provide a steady gas flow;
sealingly connecting one of a plurality of reaction vessels with a first gas flow rate, existing when the plurality of reaction vessels are connected in parallel to a common gas feed with a fixed pressure, to the controlled vacuum source;
setting a gas flow controller to a gas flow rate to produce a measurable first pressure drop reading on a vacuum gauge at a chosen gas flow rate and a measurable, predetermined second pressure drop reading within a predetermined range on the vacuum gauge at the chosen gas flow rate;
adding an amount of at least one of a plurality of condensed phased materials to the reaction vessel with the first gas flow rate to produce the predetermined second pressure drop reading corresponding to a second gas flow rate, existing when the plurality of reaction vessels are connected in parallel to a common gas feed with a fixed pressure; and
replacing the reaction vessel with each of the plurality of reaction vessels, in turn, and adding an amount of at least one of the plurality of condensed phase materials to each of the plurality of reaction vessels, each with a first gas flow rate, wherein the first gas flow rate is different for each of the plurality of reaction vessels, to produce the predetermined second pressure drop reading corresponding to the second gas flow rate, wherein the second gas flow rate is substantially the same for each of the plurality of reaction vessels.

34. The method of claim 33, wherein the predetermined second pressure drop and the predetermined second pressure drop range are dependent on such factors as the type of condensed phase materials being used and their porosity; the required range for the amount of catalysts or reagents for the reactions of interest; the required range for the gas flow rate required for the reactions of interest; the diameter of the reaction vessels being used; the measurement range of the vacuum gauge being used, experience with prior gas-condensed phase reactions; and any other similar factors.

35. The method of claim 33, wherein each of the plurality of reaction vessels has appropriate supports for supporting a condensed phase material bed disposed within each of the plurality of reaction vessels, the gas flow through each of the plurality of reaction vessels being adjusted by varying the amount of condensed phase material composing the condensed phase material bed.

36. The method of claim 35, further comprising agitating the reaction vessel and/or condensed phase material bed.
